(19) United States
(12) Patent Application Publication
(10) Pub. No.: US 2024/0246304 A1
(43) Pub. Date: Jul. 25, 2024

(54) SEALANT COMPOSITION AND TIRE USING THE SAME

(71) Applicant: THE YOKOHAMA RUBBER CO., LTD., HIRATSUKA-SHI, KANAGAWA (JP)

(72) Inventors: Yuichiro KARASAWA, HIRATSUKA SHI, KANAGAWA (JP); Takeaki SAIKI, HIRATSUKA-SHI, KANAGAWA (JP); Takahiro OKAMATSU, HIRATSUKA-SHI, KANAGAWA (JP)

(21) Appl. No.: 18/271,900

(22) PCT Filed: Dec. 24, 2021
(86) PCT No.: PCT/JP2021/048116

§ 371 Date: Jul. 12, 2023

(30) Foreign Application Priority Data
Jan. 21, 2021 (JP) 2021-008246

(51) Int. Cl. B29C 73/16; C08K 3/06; C08K 5/00; C08K 5/405; C08K 5/44; C08L 7/00

(52) U.S. Cl. CPC B29C 73/163; C08K 3/06; C08K 5/0016; C08K 5/0025; C08K 5/405; C08K 5/44; C08L 7/00; C08K 2201/019; C08L 2205/025

(57) ABSTRACT

A sealant composition of the present invention is formed by blending, per 100 parts by mass of a rubber component (A), 5 parts by mass or more of a tackifier (B), 60 parts by mass or more of a plasticizer (C), 0.1 to 10 parts by mass of sulfur (D), and 0.1 to 10 parts by mass of a vulcanization accelerator (E) (excluding a thiuram-based vulcanization accelerator, however), and thus the sealant composition can provide improved sealability, viscosity temperature dependency, and fluidity during storage of a tire.

### TECHNICAL FIELD

The present invention relates to a sealant composition and a tire using the same.

### BACKGROUND ART

Among pneumatic tires, a pneumatic tire is known that is provided with a sealant layer disposed on an inner side of an innerliner layer in a tire radial direction in a tread portion. In such a pneumatic tire, when a foreign matter such as a nail or the like penetrates into the tread portion, a sealant flows into a through-hole, which makes it possible to suppress a decrease in air pressure and to maintain travel.

For example, Patent Document 1 below discloses a self-sealing elastomer composition including an unsaturated diene elastomer, hydrocarbon resin between 30 phr and 90 phr, and a filler of 0 to less than 30 phr.

Also, Patent Document 2 below discloses a self-sealing elastomer composition for use as a puncture preventative layer in an inflatable article, which includes at least an unsaturated diene elastomer as a main elastomer having a repeating unit content derived from a conjugated diene of more than 30 mol %, hydrocarbon resin having a mass content of between 30 phr and 90 phr, a liquid plasticizer having a glass transition temperature (Tg) of lower than −20° C. and a mass content of 5 phr to less than 60 phr, and a filler of 0 to less than 30 phr.

### CITATION LIST

### Patent Literature

Patent Document 1: JP 5646474 B
Patent Document 2: JP 5525522 B

### SUMMARY OF INVENTION

### Technical Problem

However, in the related art described above, there are problems in the sealability against through-holes formed when foreign matter such as nails or the like penetrate into the tread portion, in the viscosity temperature dependency of the sealant composition, and in the fluidity of the sealant composition during storage of the tire, and a solution to these problems is required.

An object of the present invention is to solve the aforementioned problems.

### Solution to Problem

As a result of diligent research, the inventors found that the problems described above can be solved by the sealant composition formed by blending specific amounts of a tackifier and a plasticizer in a rubber component, and thus the present invention can be completed.

The present invention provides a sealant composition forming a sealant layer of a pneumatic tire provided with the sealant layer on a tire inner surface, the sealant composition being formed by blending, per 100 parts by mass of a rubber component (A), 5 parts by mass or more of a tackifier (B), 60 parts by mass or more of a plasticizer (C), 0.1 to 10 parts by mass of sulfur (D), and 0.1 to 10 parts by mass of a vulcanization accelerator (E) (excluding a thiuram-based vulcanization accelerator, however).

### Advantageous Effects of Invention

The sealant composition of the present invention is formed by blending, per 100 parts by mass of the rubber component (A), 5 parts by mass or more of the tackifier (B), 60 parts by mass or more of the plasticizer (C), 0.1 to 10 parts by mass of the sulfur (D), and 0.1 to 10 parts by mass of the vulcanization accelerator (E) (excluding a thiuram-based vulcanization accelerator, however). According to the configuration described above, the blended amount of (B) to (E) is optimized, and the thiuram-based vulcanization accelerator is excluded, thus the sealant composition easily flows into through-holes formed in the tread portion to increase sealability and reduce viscosity temperature dependency of the sealant composition. As a result, the sealant composition can be prevented from flowing due to the influence of heat or centrifugal forces applied during travel, and the sealant composition can be inhibited from flowing during storage of the tire.

### DESCRIPTION OF EMBODIMENTS

The present invention will be described in further detail below.

### (A) Rubber Component

Examples of a rubber component (A) used in the present invention include diene rubber such as natural rubber (NR), synthetic isoprene rubber (IR), butadiene rubber (BR), styrene-butadiene copolymer rubber (SBR), acrylonitrile-butadiene copolymer rubber (NBR), ethylene-propylene-diene terpolymer (EPDM), butyl rubber, and the like. These may be used alone, or two or more may be used in combination.

In particular, from the perspective of improving the effects of the present invention, the rubber component (A) is preferably NR, IR, SBR, BR, or a blend thereof.

### (B) Tackifier

An example of a tackifier (B) used in the present invention includes hydrocarbon resin. An example of the hydrocarbon resin includes petroleum resin such as aromatic hydrocarbon resin that is manufactured by polymerizing components obtained by performing treatments such as distillation, decomposition, and reforming on crude oil, or petroleum resin such as saturated or unsaturated hydrocarbon resin. Examples of the petroleum resin include C5 petroleum resin (aliphatic petroleum resin formed by polymerizing fractions such as isoprene, 1,3-pentadiene, cyclopentadiene, methylbutene, and pentene), C9 petroleum resin (aromatic petroleum resin formed by polymerizing fractions such as α-methylstyrene, o-vinyl toluene, m-vinyl toluene, and p-vinyl toluene), C5C9 copolymer petroleum resin, and the like.

Further, the glass transition temperature (Tg) of the tackifier (B) is preferably higher than 0° ° C. By specifying Tg as just described, fluidity is improved. For the glass transition temperature (Tg) in the present invention, a thermograph is measured by differential scanning calorimetry (DSC) at a rate of temperature increase of 20° C./minute, and the temperature at the midpoint of the transition region is defined as the glass transition temperature.

The aforementioned Tg is more preferably 30° C. or higher and 90° C. or lower.

Furthermore, the number average molecular weight of the tackifier (B) is preferably from 400 to 2000. By having a number average molecular weight in this range, adhesive force is improved.

### (C) Plasticizer

Examples of the plasticizer used in the present invention are a carboxylic acid ester plasticizer, a phosphoric acid ester plasticizer, a sulfonic acid ester plasticizer, oil, liquid rubber, and the like.

Examples of the carboxylic acid ester plasticizer include publicly known phthalic acid esters, isophthalic acid esters, tetrahydrophthalic acid esters, adipic acid esters, maleic acid esters, fumaric acid esters, trimellitic acid esters, linoleic acid esters, oleic acid esters, stearic acid esters, ricinoleic acid esters, and the like.

Examples of the phosphoric acid ester plasticizer include publicly known trimethyl phosphate, triethyl phosphate, tributyl phosphate, tri(2-ethylhexyl) phosphate, 2-ethylhexyl diphenyl phosphate, tributoxyethyl phosphate, triphenyl phosphate, cresyl diphenyl phosphate, isodecyl diphenyl phosphate, tricresyl phosphate, tritolyl phosphate, trixylenyl phosphate, tris(chloroethyl) phosphate, diphenyl mono-o-xenyl phosphate, and the like.

Examples of the sulfonic acid ester plasticizer include publicly known benzene sulfone butylamide, toluenesulfonamide, N-ethyl-toluenesulfonamide, N-cyclohexyl-p-toluenesulfonamide, and the like.

Examples of the oil include publicly known mineral oils such as paraffin-based process oil, naphthene-based process oil, and aromatic process oil.

Examples of the liquid rubber include liquid polyisoprene, liquid polybutadiene, liquid polystyrene butadiene, and the like, and the average molecular weight thereof (Mn) is preferably 1000 to 100000, and more preferably 1500 to 75000. Further, the weight average molecular weight in the present invention refers to a value or a weight average molecular weight determined by gel permeation chromatography (GPC) based on calibration with polystyrene. Furthermore, the liquid rubber used in the present invention is liquid at 23° ° C. As a result, the liquid rubber is distinguished from the aforementioned rubber component that is solid at this temperature.

Of the rubbers described above, oil or liquid rubber is preferable as the plasticizer from the perspective of improving the effects of the present invention.

### (D) Sulfur

Sulfur is blended as a crosslinking agent in the sealant composition of the present invention. Although examples of the crosslinking agent can generally include sulfur, organic peroxide, and the like, sulfur is particularly used as the crosslinking agent in the present invention, and thus sealability and viscosity temperature dependency can be preferably improved.

### (E) Vulcanization Accelerator

The vulcanization accelerator used in the present invention is preferably one or more types selected from a thiazole-based vulcanization accelerator, a sulfenamide-based vulcanization accelerator, and a thiourea-based vulcanization accelerator.

Examples of the thiazole-based vulcanization accelerator include 2-mercaptobenzothiazole, dibenzothiazyl disulfide, and the like.

Examples of the sulfenamide-based vulcanization accelerator include
N-cyclohexyl-2-benzothiazolylsulfenamide,
N-tert-butyl-2-benzothiazolylsulfenamide,
N,N′-dicyclohexyl-2-benzothiazolylsulfenamide, and the like.

Examples of the thiourea-based vulcanization accelerator include diethylthiourea, dibutylthiourea, dilaurylthiourea, diphenylthiourea, di(o-tolyl)thiourea, trimethylthiourea, ethylenethiourea, and the like.

In the present invention, no thiuram-based vulcanization accelerator is used. When a thiuram-based vulcanization accelerator is used, the crosslinking density tends to increase, which may decrease adhesive force due to vulcanization, and in some cases, may result in unfavorable sealing performance.

### Blending Ratio of Sealant Composition

The sealant composition of the present invention is formed by blending, per 100 parts by mass of the rubber component (A), 5 parts by mass or more of the tackifier (B), 60 parts by mass or more of the plasticizer (C), 0.1 to 10 parts by mass of the sulfur (D), and 0.1 to 10 parts by mass of the vulcanization accelerator (E).

When the blended amount of the tackifier (B) is less than 5 parts by mass per 100 parts by mass of the rubber component (A), the blended amount is too small, and thus the effects of the present invention cannot be achieved. The blended amount of the tackifier (B) is preferably 5 to 100 parts by mass, and more preferably 20 to 60 parts by mass.

When the blended amount of the plasticizer (C) is less than 60 parts by mass per 100 parts by mass of the rubber component (A), sealability deteriorates. The blended amount of the plasticizer (C) is preferably 60 to 150 parts by mass, and more preferably 60 to 100 parts by mass.

When the blended amount of the sulfur (D) is less than 0.1 part by mass per 100 parts by mass of the rubber component (A), the blended amount is too small, and thus the effects of the present invention cannot be achieved. On the other hand, when the blended amount is more than 10 parts by mass, adhesive force decreases and sealability deteriorates. The blended amount of the sulfur

(D) is preferably 0.5 to 5.0 parts by mass.

When the blended amount of the vulcanization accelerator (E) is less than 0.1 part by mass per 100 parts by mass of the rubber component (A), the blended amount is too small, and thus the effects of the present invention cannot be achieved. On the other hand, when the blended amount is more than 10 parts by mass, adhesive force decreases and sealability deteriorates. The blended amount of the vulcanization accelerator (E) is preferably 0.5 to 3.0 parts by mass.

### Other Components

Various additives such as zinc oxide, an anti-aging agent, and carbon black other than the aforementioned components can be blended in the sealant composition of the present invention. Such additives can be kneaded by a typical method to form a composition, and the blended amount of the additives can be a typical blended amount in the related art unless contrary to the object of the present invention.

The sealant composition of the present invention uses sulfur as the vulcanizing agent and can be dynamically cross-linked.

The sealant composition of the present invention can be provided as a sealant layer on an inner side of an innerliner layer in a tire radial direction in a tread portion in a pneumatic tire. The sealant layer can be formed by attaching a sheet-shaped molded sealant made of the sealant composition of the present invention to the entire circumference of the tire inner surface. Alternatively, the sealant layer can be formed by spirally attaching a string-shaped or band-shaped molded sealant made of the sealant composition of the present invention to the tire inner surface. With the sealant layer, when a foreign matter such as a nail or the like penetrates into the tread portion, the sealant constituting the sealant layer flows into the through-hole, and as a result, a decrease in air pressure can be suppressed and travel can be maintained. The sealant layer has a thickness of, for example, 0.5 mm to 5.0 mm.

### EXAMPLES

The present invention will be described in further detail by way of examples and comparative examples, but the present invention is not limited by these examples. Additionally, in the following examples, “parts” means “parts by mass”.

Examples 1 to 9 and Comparative Example 1 According to the composition (parts by mass) shown in Table 1, kneading is performed for 40 minutes in a 1.7-L sealed Banbury Mixer, and a rubber composition was obtained. Next, the obtained rubber composition was press-vulcanized in a predetermined mold at 180° ° C. for 10 minutes to obtain a sealant having a thickness of 3 mm.

In a pneumatic tire having a tire size of 215/55R17, including a tread portion, a pair of sidewall portions, and a pair of bead portions, and including a sealant layer made of a sealant on an inner side of the innerliner layer in a tire radial direction in the tread portion, the sealant was attached as the sealant layer to manufacture various test tires. The following physical properties were measured for the obtained test tires.

### Sealability:

The test tires were assembled on wheels having a rim size of 17×7J and mounted on a test vehicle, with an initial air pressure of 250 kPa, a 4 mm-diameter nail was driven into the tread portion, and then the test tires were left to stand for one hour after the nail was removed. Thereafter, the air pressure was measured. The evaluation results were indicated by “good” in a case where the air pressure after the tire was left to stand was 230 kPa or higher and 250 kPa or lower, by “fair” in a case where the air pressure after the tire was left to stand was 200 kPa or higher and less than 230 kPa, and by “poor” in a case where the air pressure after the tire was left to stand was less than 200 kPa.

Fluidity of Sealant:

The test tires were assembled on wheels having a rim size of 16×6.5J, mounted on a drum testing machine, and subjected to high deflection test with an air pressure of 160 kPa, a load of 8.5 kN, and a traveling speed of 80 km/h for 80 hours, and then the flow state of the sealant was examined. The evaluation results were as follows: Given that, when the 3 mm thickness of the sealant was 1.5 mm or less after testing at each position from the sealant end, it was determined that flow was observed, the case where no flow was observed at a position 1 cm away from the sealant end was indicated by “good”, the case where flow was observed at a position 1 cm away from the sealant end and no flow was observed at a position 2 cm away from the sealant end was indicated by “fair”, and the case where flow was observed at a position 2 cm away from the sealant end was indicated by “poor”.

Storability: The test tires were left in an oven at 30ºC for one week to examine storability. The evaluation results are determined by fluidity from the outer end in the tire width direction of the sealant layer. The case where no sealant flow was observed is indicated by “good”, the case where sealant flow occurred in a region within 1 cm away from the end is indicated by “fair”, and the case where sealant flow occurred in a region 1 cm or more away from the end is indicated by “poor”.

The results are shown in Table 1.

TABLE 1

| | | Comparative | Example | Example | Example | Example | Example | Example | Example | Example | Example |
|---|---|---|---|---|---|---|---|---|---|---|---|
| Blend | | Example 1 | 1 | 2 | 3 | 4 | 5 | 6 | 7 | 8 | 9 |
| NR | 1) | 50 | 60 | 60 | 60 | 60 | 60 | 60 | 60 | 60 | 60 |
| BR | 2) | 50 | | | | | | | | | |
| SBR | 3) | | 40 | 40 | 40 | 40 | 40 | 40 | 40 | 40 | 40 |
| Plasticizer 1 | 4) | 15 | | | | | | | | | |
| Plasticizer 2 | 5) | | 60 | 60 | 60 | 60 | 60 | 60 | 60 | 60 | 60 |
| Tackifier 1 | 6) | 50 | | | | | | | | | |
| Tackifier 2 | 7) | | 20 | 20 | 20 | 30 | 30 | 30 | 60 | 60 | 60 |
| Carbon black | 8) | 1 | | | | | | | | | |
| Sulfur | 9) | | 0.5 | 0.75 | 1 | 0.5 | 0.75 | 1 | 0.5 | 0.75 | 1 |
| Thiuram-based | 10) | 3 | | | | | | | | | |
| vulcanization | | | | | | | | | | | |
| accelerator | | | | | | | | | | | |
| Thiazole | 11) | | 1 | 1 | 1 | 1 | 1 | 1 | 1 | 1 | 1 |
| vulcanization | | | | | | | | | | | |
| accelerator | | | | | | | | | | | |
| Sealability | | Good | Good | Good | Good | Good | Good | Good | Good | Good | Good |
| Fluidity | | Poor | Good | Good | Good | Good | Good | Good | Good | Good | Good |
| Storability | | Good | Good | Good | Good | Good | Good | Good | Good | Good | Good |

1): NR (SIR20)
2): BR (Nipol BR1220 available from Zeon Corporation)
3): SBR (Nipol 1502 available from Zeon Corporation)
4): Plasticizer 1 (Ricon 154, liquid butadiene rubber available from CRAY VALLEY)
5): Plasticizer 2 (Diana Process Oil NP250 available from Idemitsu Kosan Co., Ltd.)
6): Tackifier 1 (Escorez 2101, C5/C9 petroleum resin available from Exxon Mobil Corporation)
7): Tackifier 2 (T-REZ RC115, C5 petroleum resin available from ENEOS Corporation)
8): Carbon black (Carbon black N772)
9): Sulfur (Golden Flower oil treated sulfur powder available from Tsurumi Chemical Industry Co., Ltd.)
10): Thiuram-based vulcanization accelerator (SANCELER TBZTD available from Sanshin Chemical Industry Co., Ltd.)
11): Tiazole-based vulcanization accelerator (SANCELER DM-PO available from Sanshin Chemical Industry Co., Ltd.)

From the results shown in Table 1, since the sealant composition of each Example is formed by blending 5 parts by mass or more of a tackifier (B), 60 parts by mass or more of a plasticizer (C), 0.1 to 10 parts by mass of sulfur (D), and 0.1 to 10 parts by mass of a vulcanization accelerator (E) (excluding a thiuram-based vulcanization accelerator, however) per 100 parts by mass of a rubber component (A), good results were obtained in all of scalability, fluidity (viscosity temperature dependency), and storability.

On the other hand, in Comparative Example 1, since the blended amount of the plasticizer (C) is 15 parts by mass per 100 parts by mass of the rubber component (A), and the thiuram-based vulcanization accelerator is blended as the vulcanization accelerator (E), the fluidity and the storability deteriorated.

1. A sealant composition forming a sealant layer of a pneumatic tire provided with the sealant layer on a tire inner surface, the sealant composition being formed by blending, per 100 parts by mass of a rubber component (A), 5 parts by mass or more of a tackifier (B), 60 parts by mass or more of a plasticizer (C), 0.1 to 10 parts by mass of sulfur (D), and 0.1 to 10 parts by mass of a vulcanization accelerator (E) (excluding a thiuram-based vulcanization accelerator, however).

2. The sealant composition according to claim 1, wherein the vulcanization accelerator (E) is one or more types selected from a thiazole-based vulcanization accelerator, a sulfenamide-based vulcanization accelerator, and a thiourea-based vulcanization accelerator.

3. The sealant composition according to claim 1, wherein the rubber component is natural rubber, synthetic isoprene rubber, styrene-butadiene copolymer rubber, butadiene rubber, or a blend of the rubbers.

4. The sealant composition according to claim 1, wherein the tackifier is hydrocarbon resin.

5. The sealant composition according to claim 4, wherein the hydrocarbon resin is C5 petroleum resin, C9 petroleum resin, or C5C9 copolymer petroleum resin.

6. The sealant composition of claim 4, wherein the hydrocarbon resin has a glass transition temperature higher than 0° C.

7. The sealant composition according to claim 6, wherein the glass transition temperature is 30° C. or higher and 90° ° C. or lower.

8. The sealant composition according to claim 4, wherein the hydrocarbon resin has a number average molecular weight of 400 to 2000.

9. The sealant composition according to claim 1, wherein the plasticizer is oil or liquid rubber.

10. The sealant composition according to claim 1, wherein
the plasticizer is liquid rubber selected from liquid polyisoprene, liquid polybutadiene, and liquid polystyrene butadiene, and
the liquid rubber has a weight average molecular weight of 1000 to 100000.

11. A tire using the sealant composition according to claim 1.
